(19) United States
(12) Patent Application Publication
(10) Pub. No.: US 2005/0216279 A1
(43) Pub. Date: Sep. 29, 2005

(54) A Method of Simplifying E-commerce Marketplace Mail Order Sellers Invoicing, Accounting and Label Printing

(76) Inventor: Yefim Goldin, Studio City, CA (US)

Correspondence Address: JEFFREY FURR, 253 N. MAIN STREET, JOHNSTOWN, OH, 43031, US

(21) Appl. No.: 10/708,844

(22) Filed: Mar. 26, 2004

(51) Int. Cl. G06F 17/60

(52) U.S. Cl. 705/1; 705/26; 705/40

(57) ABSTRACT

The present invention provides a system and method for the marketplace invoices generating and management. The system is a web based software created to assist marketplace sellers, such as those on E-bay, half.com, amazon.com and others, in invoices generation and simplifying printing the invoices and mailing labels. Since the invention is web based software there's no need to install anything on a user”s computer. The invention allows the user to register on the website and start processing and printing the invoices. The system extracts (parses) information directly from the websites, not from the emails. There's no need to set it up with a user”s email software. The system is set up to print all invoices at once as a batch versus individual invoices which will save hours daily. All the user does is specify the range of invoices that they would like to print and click the print button from the user”s web browser such as Internet Explorer. The system also extracts name, an address and email information to form XML file for batch label printing by system”s postal software.

### BACKGROUND OF INVENTION

1. Field of the Invention

This invention relates to the art of combining and providing invoices, specifically to the use of the Internet and a web site for this purpose.

2. Description of Prior Art

At present in order for a merchant to retrieve customer orders from different websites they have to: 1. Open their email messages with the order confirmation, print the orders one by one, then cut and paste customer address into a label printing software. or 2. Log in to web site (Amazon.com, half.com, paypal.com, http://www.abebooks.com/, http://www.alibris.com/, http://www.amazon.ca/, http://www.amazon.co.uk, http://www.amazon.de, and http://www.amazon.co.jp) and print the orders one by one, then cut and paste customer address into a label printing software. These processes take hours to retrieve and print the orders and labels.

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

Prior Art U.S. Pat. No. 6,625,267 by Graham, et al. and issued on Sep. 23, 2003 is for a “Billing system.” It discloses a billing system for a service provider-client environment, which includes a service provider site, a first computer-based device disposed at the service provider site having billing software operably associated with the first computer-based device for enabling logging of client data and service provider data.

U.S. Pat. No. 6,609,113 by O'Leary, et al. and issued on Aug. 19, 2003 is for a “Method and system for processing internet payments using the electronic funds transfer network.” It discloses a system and method for effectuating Electronic Funds Transfer credit messages.

U.S. Pat. No. 6,374,229 by Lowrey, et al. and issued on Apr. 16, 2002 is for an “Integrated internet facilitated billing, data processing and communication system.” It discloses a database server and a Citrix.RTM.-type direct access server electronically interconnected between said database server and a plurality of subscribers, each of which gain secure access into a server via a modem and an internet service provider (ISP).

U.S. Pat. No. 6,327,577 Garrison, et al. and issued on Dec. 4, 2001 is for an “Electronic bill payment system with account-number scheming.” It discloses a remittance payment method and system which receives a payor's account number with a payee, transforming it into an altered account number according to alteration rules previously stored in a merchant's database.

U.S. Pat. No. 6,317,745 by Thomas, et al. and issued on Nov. 13, 2001 is for a “Trusted third party data structure for electronic funds transfer and bill presentment.” It discloses a funds transfer system for facilitating electronic funds transfer between a payor and a payee.

U.S. Pat. No. 6,289,322 by Kitchen, et al. and issued on Sep. 11, 2001 is for “Electronic bill processing.” It discloses a method of electronically presenting billing information, and includes receiving billing information associated with a plurality of different billers, different portions of which represent bills for different payors. Requests are received from respective payors for current billing information, responsive to which bill presentment information corresponding to the applicable portion of the billing information is transmitted to the requesting payor.

The need for a better method for the combining and sending of invoices, that is faster, inexpensive, and easy to use shows that there is still room for improvement within the art.

### SUMMARY OF INVENTION

The object of the present invention is to provide a method of combining and sending invoices that is fast, easy, inexpensive, and convenient.

The present invention provides a system and method for the marketplace invoices generating and management. The system is a web based software created to assist marketplace sellers, such as those on E-bay, half.com, amazon.com, http://www.abebooks.com/, http://www.alibris.com/, http://www.amazon.ca/, http://www.amazon.co.uk, http://www.amazon.de, http://www.amazon.co.jp and others, in invoice generation and in simplifying printing the invoices and mailing labels. Since the invention is web based software, there's no need to install anything on a user”s computer. The invention allows the user to register on the website and start processing and printing the invoices. The system extracts (parses) information directly from the websites, not from the emails. There's no need to set it up with a user”s email software. The system is set up to print all invoices at once as a batch versus individual invoices, which will save hours daily. All the user does is specify the range of invoices that they would like to print and click the print from the user”s web browser such as Internet Explorer. The system also extracts name, an address and email information to form an XML file for batch label printing by the system”s postal software.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Clip: a video stream that contains images and possible sound.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

Uploader: someone who wants to upload a video clip or image.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Viewer: someone who wants to view the video image or clip.

Visit: a series of requests to a fixed Web server by a single person (through a browser), occurring contiguously in time.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the system main web page;

FIG. 3 displays how the system contacts other websites;

FIG. 4 displays a sample registration page; F

FIG. 5 displays a flowchart of the process of printing invoices; and

FIG. 6 displays how a user downloads orders.

### DETAILED DESCRIPTION

The current invention is a system and method for combining and sending invoices that is fast, easy, inexpensive, and convenient.

The present invention provides a system and method for the marketplace invoices generating and management. It is a web based software system 1 created to assist marketplace sellers 20, such as those on E-bay, half.com, amazon.com, http://www.abebooks.com/, http://www.alibris.com/, http://www.amazon.ca/, http://www.amazon.co.uk, http://www.amazon.de, http://www.amazon.co.jp and others, in invoice generation and in simplifying printing the invoices 40 and mailing labels 50. Since it is web based software 100, there's no need to install anything on a user”s computer. The current invention allows the user 10 to register on the website and start processing and printing the invoices 40. The system 1 extracts (parses) information directly from the websites 200, not from the emails.

The system 1 is set up to print all invoices 40 at once as a batch versus individual invoices which will save hours daily. All the user does is specify the range of invoices that they would like to print and click the print from the user”s web browser 60 such as Internet Explorer. The system 1 also extracts name, an address and email information to form XML file for batch label printing by system”s postal software.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

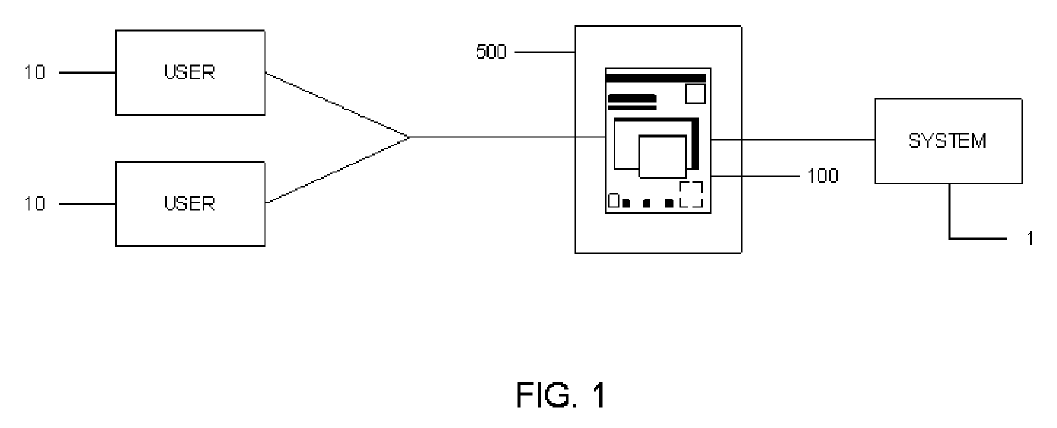

FIG. 1 illustrates a functional diagram of a computer network for World Wide Web access to the system 1 from a plurality of Users 10 to the web site 100. Accessing the web site 100 can be accomplished directly through a communication means such as a local Internet Service Provider, often referred to as ISPs, or through an on-line service provider like CompuServe, Prodigy, American Online, etc.

The Users 10 contact the web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, 2000, XP or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

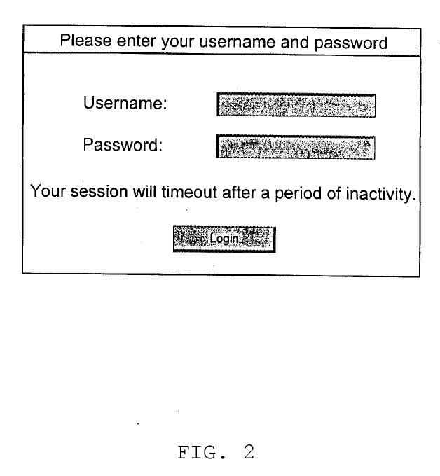

In one preferred embodiment of the invention, the Users 10 connect to the Web site 100. The system 1 would have a standard home web page 200 as shown in FIG. 2. This home web page 200 would have information about the system 1 as well as a standard login as shown in FIG. 2. The home web page 200 would have hypertext to other specialized web pages. In the preferred embodiment, these would be; why use the process, Pricing, Options, Buyer FAQ”s, Terms and Conditions, Privacy Statement, Account, Card Status and Customer Service.

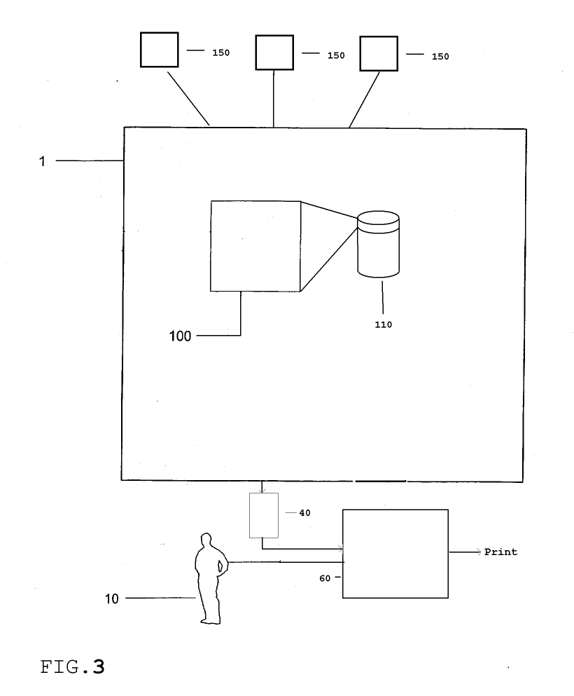

As shown in FIG. 3, the system 1 is a web based system. It will contact other websites 150 such as E-bay, Halfbid.com and amazon.com, http://www.abebooks.com/, http://www.alibris.com/, http://www.amazon.ca/, http://www.amazon.co.uk, http://www.amazon.de, http://www.amazon.co.jp and pull off the invoice information from those web sites. The system 1 combines that information into a single invoice 40. The system 1 is set up to print all invoices 40 at once as a batch print. The user 10 specifies the range of invoices 40 that they would like to print. The invoices 40 are printed from the user”s web browser 60. The system 1 has a data storage means 110 on which the software 100 and data is stored. This data storage means can be one or a number of standard data storage means such as RAM, magnetic disks or CD-ROMS.

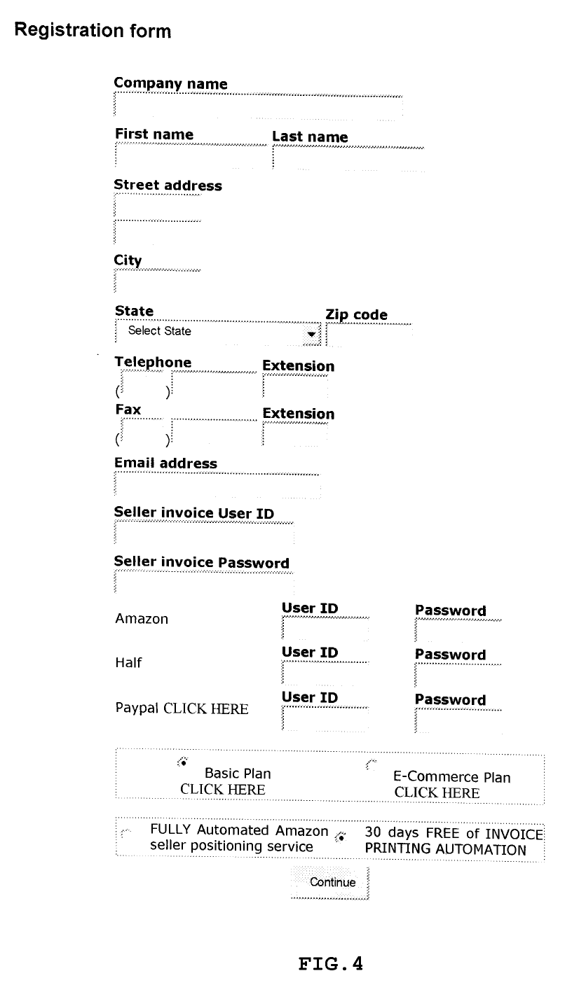

A user 10 must register the information on the system 1 into the software 100 and the data storage means 110. FIG. 4 displays a sample registration web page 300 that is used by the system. The user 10 will input the company name, the first name of the contact person, the last name of the contact person, a street address, city, state (which is a drop down box in the preferred embodiment), telephone number, fax number, and email address. The user 10 will select and enter a Seller invoice user ID as well as a password for that ID. The system 1 will require that the user 10 inputs their user id and password for all of the sites 150 that the system 1 is going to process invoices for such as Amazon, eBay, Half, PayPal., http://www.abebooks.com/, http://www.alibris.com/, http://www.amazon.ca/, http://www.amazon.co.uk, http://www.amazon.de, http://www.amazon.co.jp The user 10 can also pick different levels of service plans for the system 1.

The web site 100 would have an FAQ web page which would be a standard FAQ web page. This technology is also well known in the art.

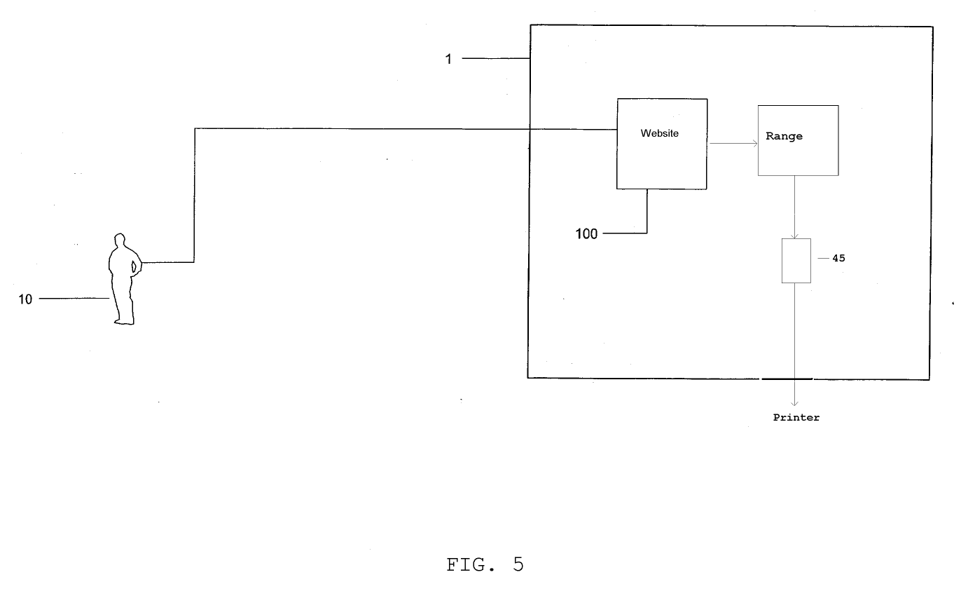

As shown in FIG. 5, the system 1 allows the printing of orders 45 by having the user 1 log in to the system”s website 100 and sign into their user account. The user 10 chooses orders range that they would like to print using a command such as: “View invoices from” ______ to ______.” The user 10 Clicks “View.” If these are the invoices 40 that the user 10 requested, the user 10 uses the file print function from their web browser system 60.

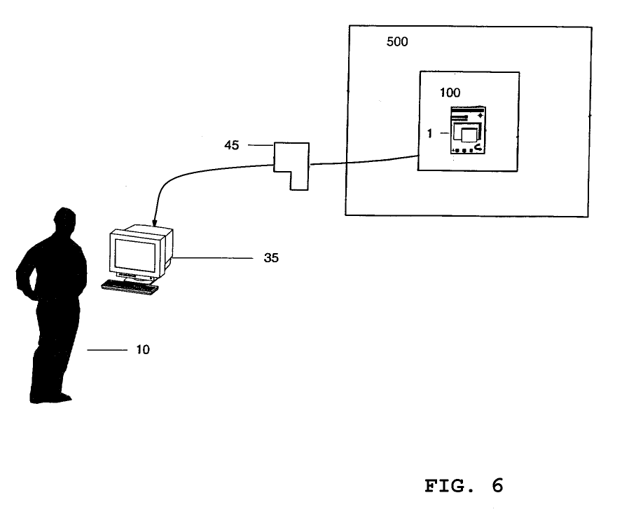

As displayed in FIG. 6, a user 10 can save all of their orders 45 by downloading their orders 45 from the system 1. This is downloaded to the user”s own computer 35. The user 10 would click on “Download complete order file” and click “Save.” In the preferred embodiment, the file would have CSV (comma delimited) format and can be used with Microsoft Excel, Microsoft Works, and many other applications. The user 10 also has the option to save their customers “Name and Address” information. The user 10 clicks on “Name and Address only file” and clicks “Save.” This file also would be in CSV (comma delimited) format and may be used with Microsoft Excel, Microsoft Works, and many other applications.

The user 10 may import the “Name and Address only file” 142 to the system”s 1 Postage and Labels Printing function 145.

The user 10 may save the customer information for the current date by clicking on “Name and Address only file MMDDYYYY” on the website 100 of the software 1.

In the preferred embodiment, the system 1 has two ways to print a mailing label 30. The first method is Half automated. In this method the user 10 saves “Name and Address only file”, opens the Postage and Labels Printing function 145, clicks on “Address Book”, clicks “File/Import”, chooses the Name and Address file and clicks “OPEN”, clicks on name they would like to print and clicks on “print” button. The Half automated method of printing will be helpful for printing no more than 50 labels per day.

For more than 50 labels per day, the Full Automated Labels and Postage Printing option is preferred. For this method the user 10 logs in to their user account, clicks on “Set up # here”, chooses the options fitting their mailing needs, and clicks “Continue.” The system 1 manages inventory for all Amazon International sites, http://www.amazon.ca/, http://www.amazon.co.uk, http://www.amazon.de, and http://www.amazon.co.jp and others. It used inventory loaded to Amazon USA http://www.amazon.com and spreads it to Amazon International sites. It also automatically re-list sold out items on any of International site. In case if the item is sold on any of Amazon International site and quantity left is 0, it goes to Amazon USA and verifies if by ASIN code if any quantity of this product left on Amazon USA and if the quantity if>1 then it re-list the item on Amazon International site that sold this item.

The system 1 PRICELEADER function also provide with price adjustment for all items on all sites such as Amazon sites; http://www.amazon.com, http://www.amazon.ca/, http://www.amazon.co.uk, http://www.amazon.de, and http://www.amazon.co.jp. The User 10 chooses interval. It may be daily, twice per day, or hourly. The user 10 fills out ?minimum price? fields of the table for items sold on Amazon.com and Amazon International sites. The Priceleader function checks each item sold on all web sites by seller and in case if the price is not lowest in the category (new, used, collectible) and the price is higher than minimum price then the price is adjusted 1 cent lower than current minimum price of the item sold by different seller. The System 1 will be written using programming languages, techniques and knowledge that are commonly known in the art.

### ADVANTAGES AND CONCLUSION

The system 1 will complete invoice printing automation and save the user 10 hours on printing marketplace invoices. The system is a web based interface that will print all daily Amazon.com, HALF.com, PAYPAL.com, http://www.abebooks.com/, http://www.alibris.com/, http://www.amazon.ca/, http://www.amazon.co.uk, http://www.amazon.de, and http://www.amazon.co.jp invoices at once as a batch. The system alleviates the need to Copy and Paste when processing invoices. There's no need to install anything on a user”s computer and the system prints from the user”s web browser. The user does not have to watch their email. The user just signs up, logs in and starts printing invoices.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for combining and sending of invoices comprising: having a web-based system which contacts and retrieves invoice information from a plurality of other websites.

2. A system according to claim 1 which includes having the system print out combined invoices using a web browser.

3. A system according to claim 1 in which the system would login to a plurality of websites, retrieve information and return said information back to said system.

4. A system according to claim 1 in which uses the Internet.

5. A system according to claim 1 in which the user connects to the system using a computer.

6. A system according to claim 1 in which the user connects to the system using an ISP.

7. A system according to claim 1 in which a plurality of users connect to said system.

8. A system according to claim 7 in which said users register on said system.

9. A system according to claim 8 in which said users register on a registration web page.

10. A system according to claim 7 in which said users selects a range of invoices to be processed.

11. A system according to claim 7 in which said users can view said invoices.

12. A system according to claim 1 in which said system produces a file in comma delimited format.

13. A system according to claim 1 in which said system will retrieve name and address information.

14. A system according to claim 13 in which said information is used to print mailing labels.

15. A system according to claim 13 in which said system has a half automated method of printing labels.

16. A system according to claim 13 in which said system has an automated method of printing labels.

17. A system according to claim 13 in which said system has an automated and half automated method for printing labels.
